(19) United States
(12) Patent Application Publication
(10) Pub. No.: US 2011/0304855 A1
(43) Pub. Date: Dec. 15, 2011

(54) APPARATUS FOR MEASURING SURFACE MISALIGNMENT AND ANGULAR MISALIGNMENT

(75) Inventors: Nobuaki UEKI, Saitama (JP); Hideo KANDA, Saitama (JP)

(73) Assignee: FUJIFILM CORPORATION, Tokyo (JP)

(21) Appl. No.: 13/157,791

(22) Filed: Jun. 10, 2011

(30) Foreign Application Priority Data
Jun. 15, 2010 (JP) 2010-136625

(51) Int. Cl. G01B 11/14

(52) U.S. Cl. 356/508

(57) ABSTRACT

Through a first diffraction grating, two conical fluxes different in wavefront propagation angle relative to its optical axis are applied to a first surface. Through a second diffraction grating, two conical fluxes different in wavefront propagation angle relative to its optical axis are applied to a second surface. Two sets of interference fringes formed by the fluxes reflected from the first surface and a reference beam are analyzed to obtain surface misalignment and angular misalignment of the first surface relative to the optical axis. Similarly, two sets of interference fringes formed by the fluxes reflected from the second surface and the reference beam are analyzed to obtain surface misalignment and angular misalignment of the second surface relative to the optical axis. Surface misalignment and angular misalignment of a sample lens are obtained from the measurement results of the first and second surfaces.

### BACKGROUND OF THE INVENTION

1. Field of the invention

The present invention relates to an apparatus for measuring surface misalignment and angular misalignment between two or more sample surfaces each having a rotationally symmetric curved portion.

2. Description Related to the Prior Art

When an aspheric lens is produced using polymer injection molding or glass molding, surface misalignment and/or angular misalignment between two surfaces of the lens occurs if two molding dies are misaligned and/or tilted relative to each other. Here, the surface misalignment refers to relative positional deviation between center points of the two lens surfaces. The angular misalignment refers to a relative tilt angle between center lines or axes of the two lens surfaces. Such surface misalignment and angular misalignment cause increase in aberration of the aspheric lens. Accordingly, it is preferable to eliminate the relative positional deviation and make the relative tilt angle zero. It is desired to measure the surface misalignment and the angular misalignment of the aspheric lens with high accuracy and to feed back the measurement results to adjust the molding dies.

Conventionally, a deflection tester disclosed in Japanese Patent No. 3127003 has been known as a method for measuring the surface misalignment and the angular misalignment of an aspheric lens. The deflection tester uses an autocollimator to measure the surface misalignment and the angular misalignment of an aspheric lens having a flange section protruding vertically to its optical axis.

Japanese Patent Laid-Open Publication No. 2008-249415 corresponding to U.S. Pat. No. 7,760,365 discloses another method for measuring the surface misalignment and the angular misalignment of a sample lens. In this method, transmitted wavefront measurement is performed using an interferometer provided with a null optical element to obtain comatic aberration or coma of the sample lens. Based on the coma, the surface misalignment and the angular misalignment are measured.

However, with the deflection tester using the autocollimator disclosed in the Japanese Patent No. 3127003, it is difficult to separately measure the surface misalignment and the angular misalignment of a sample lens. Moreover, the measurement accuracy of the deflection tester is insufficient.

On the other hand, the method disclosed in the Japanese Patent Laid-Open Publication No. 2008-249415 is capable of separately measuring the surface misalignment and the angular misalignment with high accuracy. However, a null optical element needs to be changed in accordance with a sample, for example, an aspheric lens, to be measured. Thus, it is difficult to measure various samples.

### SUMMARY OF THE INVENTION

An object of the present invention is to provide an apparatus for separately measuring surface misalignment and angular misalignment of a sample with high accuracy.

Another object of the present invention is to provide an apparatus for easily measuring surface misalignment and angular misalignment of various samples.

In order to achieve the above and other objects, an apparatus for measuring surface misalignment and angular misalignment between two sample surfaces of a sample according to the present invention includes a measuring beam converting element, an interferometric optical system, an imaging unit, and an analyzing unit. Each of the sample surfaces has a rotationally symmetric curved portion. The measuring beam converting element converts a measuring beam into a first deflected flux and a second deflected flux, and outputs the first and second deflected fluxes to the sample. The first deflected flux is incident perpendicularly on a first area of the sample surface and reflected as a first reflected flux from the first area. The second deflected flux is incident perpendicularly on a second area of the sample surface and reflected as a second reflected flux from the second area. The measuring beam converting element outputs the first and second reflected fluxes. The first and second deflected fluxes have different wavefront propagation angles relative to an optical axis of the measuring beam converting element.

The interferometric optical system outputs the measuring beam and forms first interference fringes and second interference fringes. The first interference fringes are formed by interference of the first reflected flux from the measuring beam converting element and a reference beam. The second interference fringes are formed by interference of the second reflected flux from the measuring beam converting element and the reference beam. The imaging unit images the first and second interference fringes. The analyzing unit analyzes the surface misalignment and the angular misalignment based on phase information of the first and second interference fringes obtained for each of the two sample surfaces.

It is preferable that each of the deflected fluxes is a conical flux.

It is preferable that the measuring beam converting element is a diffraction grating.

It is preferable that the apparatus further includes a reference plate having first and second surfaces. The first surface separates an incident laser beam into the measuring beam and the reference beam. The second surface is the diffraction grating.

It is preferable that the two measuring beam converting elements, the two interferometric optical systems, and the two imaging units are arranged per sample to obtain the phase information of the first and second interference fringes for each of the two sample surfaces. The sample is placed between the two measuring beam converting elements, and between the two interferometric optical systems, and between the two imaging units.

In the apparatus for measuring the surface misalignment and the angular misalignment of the present invention, the measuring beam converting element converts the measuring beam outputted from the interferometric optical system into two or more deflected fluxes different in wavefront propagation angle. The deflected fluxes are incident on the two sample surfaces of the sample. For each of the sample surfaces, the surface misalignment and the angular misalignment are measured based on the phase information of interference fringes formed by the reference beam and the fluxes reflected from an area on which the deflected fluxes are incident perpendicularly.

By applying the deflected fluxes different in wavefront propagation angle to each of the sample surfaces, two or more sets of interference fringes different in phase information are obtained for each of the sample surfaces. By analyzing the phase information of the interference fringes, relative surface misalignment and relative angular misalignment of each sample surface are separately measured with high accuracy.

The measurement is performed using the same measuring beam converting element for various samples as long as each sample surface has an area on which the deflected fluxes are incident perpendicularly. Thus, the measurement of various samples becomes possible.

### BRIEF DESCRIPTION OF THE DRAWINGS

The above and other objects and advantages of the present invention will be more apparent from the following detailed description of the preferred embodiments when read in connection with the accompanied drawings, wherein like reference numerals designate like or corresponding parts throughout the several views, and wherein:

FIG. 1 is a schematic diagram of an apparatus for measuring surface misalignment and angular misalignment according to an embodiment of the present invention; and

FIG. 2 is an explanatory view of a reference plate with a diffraction grating.

### DESCRIPTION OF THE PREFERRED EMBODIMENTS

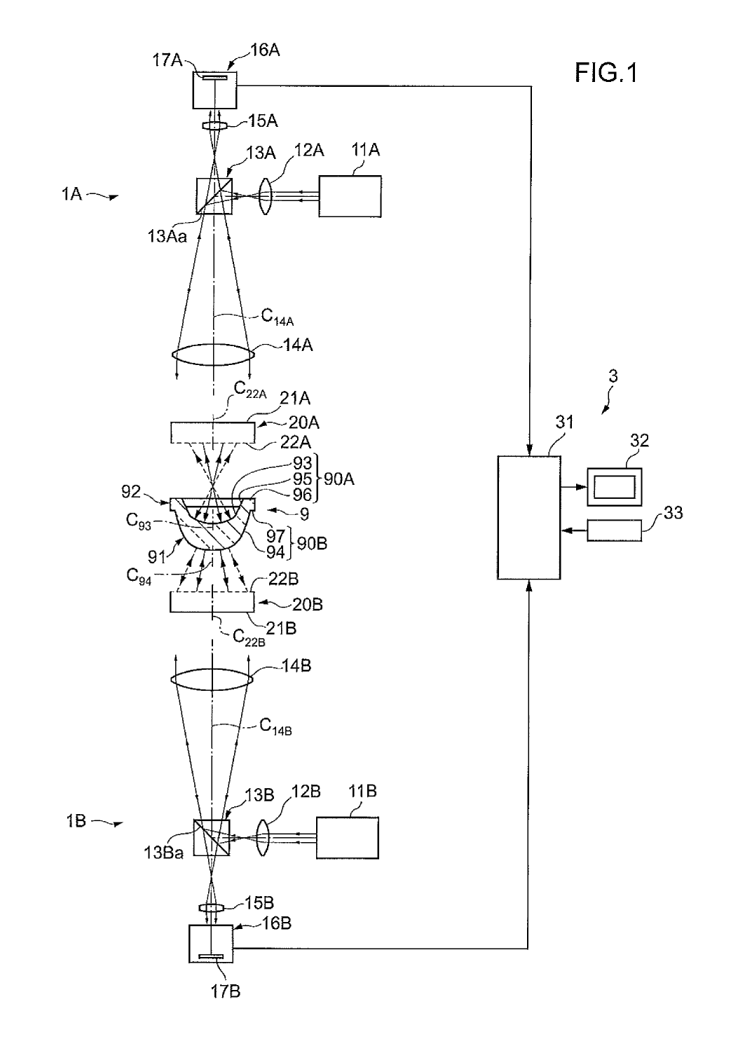

In FIG. 1, an apparatus for measuring surface misalignment and angular misalignment between surfaces of a sample lens 9 is provided with a first measuring unit 1A, a second measuring unit 1B, and an analyzing unit 3. The first and second measuring units 1A and 1B face each other with the sample lens 9 therebetween.

The sample lens 9 is an aspheric lens produced from molten polymer injected into a cavity enclosed by a pair of two molding dies (not shown). The sample lens 9 has a flange section 92 protruded outward around the entire circumference of a lens section 91. A first lens surface 93, a fitting surface 95, and a flange upper surface 96, which face upward, are formed by one of the two molding dies. A second lens surface 94 and a flange lower surface 97, which face downward, are formed by the other molding die. The sample lens 9 is supported by an alignment mechanism (not shown) in an adjustable manner. The first lens surface 93 is composed of a surface having a rotationally symmetric curved portion, that is, in this embodiment, an aspheric surface rotationally symmetric about a center axis C₉₃. The center axis C₉₃ is determined by an aspherical surface expression of the first lens surface 93. The fitting surface 95 is composed of a conical surface rotationally symmetric about the center axis C₉₃. The flange upper surface 96 is composed of an annular plane perpendicular to the center axis C₉₃. The sample lens 9 is a fitting lens that is fitted with another lens (not shown), to be used in combination. The fitting surface 95 is formed to come in contact with the other lens. The second lens surface 94, on the other hand, is composed of a surface having a rotationally symmetric curved portion, that is, in this embodiment, an aspheric surface rotationally symmetric about a center axis C₉₄. The center axis C₉₄ is determined by an aspherical surface expression of the second lens surface 94. The flange lower surface 97 is composed of an annular plane perpendicular to the center axis C₉₄.

The center axes C₉₃ and C₉₄ are designed to coincide with each other. However, the center axes C₉₃ and C₉₄ are often misaligned due to a positioning error between the two molding dies or the like. In this embodiment, the first lens surface 93, the fitting surface 95, and the flange upper surface 96 constitute a first sample surface 90A. The second lens surface 94 and the flange lower surface 97 constitute a second sample surface 90B. The angular misalignment of the sample lens 9 is defined as a relative tilt angle between the center axis C₉₃ of the first sample surface 90A (the first lens surface 93) and the center axis C₉₄ of the second sample surface 90B (the second lens surface 94), namely, an angle formed between the two center axis C₉₃ and C₉₄. If the center axis C₉₃ does not intersect the center axis C₉₄, the angular misalignment of the sample lens 9 is defined as an angle formed between direction vectors of the center axes C₉₃ and C₉₄. It is assumed that the first sample surface 90A (the center axis C₉₃) is tilted about a center point of the first lens surface 93 (an intersection point of the center axis C₉₃ and the first lens surface 93) as a center of rotation. It is assumed that the second sample surface 90B (the center axis C₉₄) is tilted about a center point of the second lens surface 94 (an intersection of the center axis C₉₄ and the second lens surface 94) as a center of rotation.

When the center point of the first lens surface 93 and the center point of the second lens surface 94 are orthogonally projected to a virtual plane perpendicular to one of the center axes C₉₃ and C₉₄, positional deviation between the two orthogonal projections on the virtual plane is defined as the surface misalignment.

The first measuring unit 1A is provided with a laser 11A, a beam diameter changing lens 12A, a beam splitter 13A having a beam splitting surface 13Aa, a collimator lens 14A, an imaging lens 15A, an imaging camera 16A having an image sensor 17A composed of a CCD, CMOS, or the like, and a reference plate with a diffraction grating (hereinafter simply referred to as the reference plate) 20A. The reference plate 20A is supported by an alignment mechanism (not shown) in an adjustable manner. The remaining components of the first measuring unit 1A are integrally supported in an adjustable manner by an alignment mechanism (not shown) different from that of the reference plate 20A.

The reference plate 20A is a disc-like plate provided with a reference surface 21A facing the collimator lens 14A, and a diffraction grating 22A facing the sample lens 9. The reference surface 21A separates a beam (a parallel beam), outputted from the collimator lens 14A along an optical axis C_{14A}, into two beams. One of the two beams is reflected back as a reference beam from the reference surface 21A to the collimator lens 14A. The other beam passes through the reference surface 21A and is incident on the diffraction grating 22A. The diffraction grating 22A diffracts the beam from the reference surface 21A to convert the beam into two kinds of deflected fluxes that have different wavefront propagation angles. Each of the deflected fluxes is composed of a conical flux. The deflected flux of one kind is depicted by a solid line. The deflected flux of the other kind is depicted by a broken line. The diffraction grating 22A outputs the two kinds of deflected fluxes to the first sample surface 90A. The two kinds of deflected fluxes are incident perpendicularly on two annular areas, respectively, around the center axis C₉₃ on the first lens surface 93 and reflected therefrom. The diffraction grating 22A diffracts fluxes reflected from the annular areas to convert the reflected fluxes into parallel fluxes, and outputs the parallel fluxes to the reference surface 21A.

The second measuring unit 1B is composed of a laser 11B, a beam diameter changing lens 12B, a beam splitter 13B having a beam splitting surface 13Ba, a collimator lens 14B, an imaging lens 15B, an imaging camera 16B having an image sensor 17B composed of a CCD, CMOS, or the like, and a reference plate with a diffraction grating (hereinafter simply referred to as the reference plate) 20B. The reference plate 20B is supported by an alignment mechanism (not shown) in an adjustable manner. The remaining components of the second measuring unit 1B are integrally supported in an adjustable manner by an alignment mechanism different from that of the reference plate 20B.

The reference plate 20B is a disc-like plate provided with a reference surface 21B facing the collimator lens 14B, and a diffraction grating 22B facing the sample lens 9. The reference surface 21B separates a beam (a parallel beam), outputted from One of the two beams is reflected back as a reference beam to the collimator lens 14B. The other beam is outputted to the diffraction grating 22B. The diffraction grating 22B diffracts the beam outputted from the reference surface 21B to convert the beam into two kinds of deflected fluxes different in the wavefront propagation angle. Each of the deflected fluxes is composed of a conical beam. In FIG. 1, the deflected flux of one kind is depicted by a solid line. The deflected flux of the other kind is depicted by a broken line. The diffraction grating 22B outputs the two kinds of deflected fluxes to the second sample surface 90B. The two kinds of deflected fluxes are incident perpendicularly on two annular areas, respectively, around the center axis C₉₄ on the second lens surface 94 and reflected therefrom. The diffraction grating 22B diffracts fluxes reflected from the annular areas to convert the reflected fluxes into parallel fluxes, and outputs the parallel fluxes to the reference surface 21B.

In this embodiment, there are two interferometric optical systems and two imaging units. One of the interferometric optical systems is composed of, for example, the laser 11A, the beam diameter changing lens 12A, the beam splitter 13A, the collimator lens 14A, the imaging lens 15A, and the reference surface 21A of the reference plate 20A. The other interferometric optical system is composed of, for example, the laser 11B, the beam diameter changing lens 12B, the beam splitter 13B, the collimator lens 14B, the imaging lens 15B, and the reference surface 21B of the reference plate 20B. One of the imaging units is, for example, the imaging camera 16A, and the other is the imaging camera 16B.

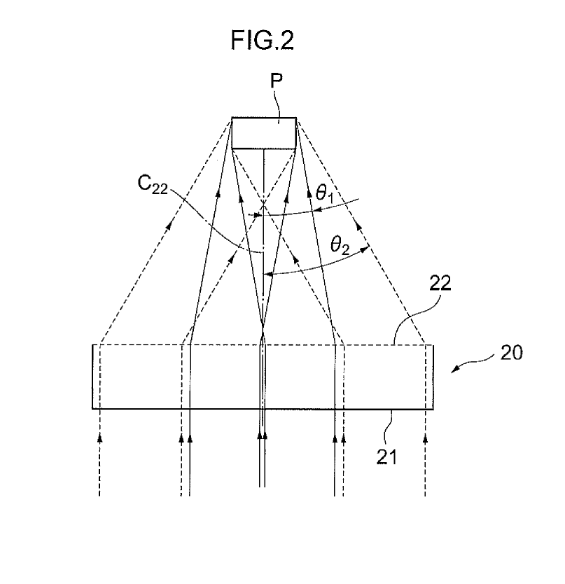

In this embodiment, there are two measuring beam converting elements. One of the measuring beam converting elements is composed of, for example, the diffraction grating 22A of the reference plate 20A. The other measuring beam converting element is composed of the diffraction grating 22B of the reference plate 20B. Referring to FIG. 2, configurations of the diffraction gratings 22A and 22B are described in a more detail using a reference plate with a diffraction grating (hereinafter simply referred to as the reference plate) 20. The reference plate 20 is similar to or the same as the reference plates 20A and 20B. The reference plate 20 is provided with a reference surface 21 and a diffraction grating 22.

The diffraction grating 22 is provided with a blazed grating composed of two or more annular regions formed around its optical axis C₂₂. A pitch and a depth of grating grooves or slits in a region (hereinafter referred to as the center region) close to the optical axis C₂₂ differ from those in a region (hereinafter referred to as the peripheral region) apart from the optical axis C₂₂. In FIG. 1, the center region is a region through which the deflected flux depicted by the solid line passes. The peripheral region is a region through which the deflected flux depicted by the broken line passes. The center region converts the parallel flux incident thereon from the reference surface 21 into a conical flux (hereinafter referred to as the first conical flux) with a wavefront propagation angle θ₁ (for example, 10 degrees) relative to the optical axis C₂₂, and outputs the first conical flux. The peripheral region converts the parallel flux incident thereon from the reference surface 21 into a conical flux (hereinafter referred to as the second conical flux) with a wavefront propagation angle θ₂ (for example, 30 degrees) relative to the optical axis C₂₂, and outputs the second conical flux.

The diffraction grating 22 is configured to collect the first conical flux and the second conical flux within a space P located in the optical axis C₂₂. A sample is placed inside the space P, allowing application of the first and second conical fluxes onto each of sample surfaces of the sample.

The analyzing unit 3 is provided with an analyzing device 31 composed of a computer or the like, a monitor device 32 for displaying an interference fringe image and the like, and an input device 33 for performing various input operations to the analyzing device 31 (see FIG. 1). The analyzing device 31 is composed of a CPU, a storage unit such as a hard disk, a program stored in the storage unit, and the like. The analyzing device 31 stores image data of two sets of the interference fringes, that is, the image data of the interference fringes taken by the imaging camera 16A and the image data of the interference fringes taken by the imaging camera 16B, and analyzes the surface misalignment and the angular misalignment of the sample lens 9 based on phase information of each set of the interference fringes.

Hereinafter, an operation of the apparatus for measuring the surface misalignment and the angular misalignment according to this embodiment is described. Prior to the measurement, the first measuring unit 1A, the second measuring unit 1B, and the sample lens 9 are aligned with each other. The alignment is performed using the above described alignment mechanisms (not shown). The alignment is performed such that the optical axis C_{14A} and the optical axis C_{14B} are parallel to each other, and the optical axis C_{22A} and the optical axis C_{22B} coincide with each other, and the optical axis C_{22A} and the optical axis C_{22B} are parallel to the optical axis C_{14A} and the optical axis C_{14B}. The center axis C₉₃ of the first sample surface 90A and the center axis C₉₄ of the second sample surface 90B substantially coincide with the optical axis C_{22A} and the optical axis C_{22B}.

After the alignment, the measurement of the sample lens 9 is performed as described in the following.

(Operation of Measurement)

<1> When the laser 11A of the first measuring unit 1A shown in FIG. 1 emits a laser beam, the laser beam is incident on the beam splitter 13A through the beam diameter changing lens 12A. The beam splitting surface 13Aa of the beam splitter 13A reflects the incident laser beam downward. The reflected laser beam is incident on the collimator lens 14A. The collimator lens 14A converts the incident laser beam into a collimated beam and outputs the collimated beam to the reference plate 20A.

<2> The reference surface 21A of the reference plate 20A separates the incident laser beam into the two beams. One of the beams is reflected back as the reference beam to the collimator lens 14A. The other is outputted to the diffraction grating 22A.

<3> The diffraction grating 22A converts the incident parallel beam into the two conical fluxes (the first conical flux and the second conical flux). The first and second fluxes are different in the wavefront propagation angle. The first and second fluxes are outputted to the first sample surface 90A.

<4> The first and second conical fluxes outputted from the diffraction grating 22A are incident perpendicularly on the two annular areas around the center axis C₉₃ on the first lens surface 93, respectively. The first conical flux is retroreflected from one of the annular areas on which the first conical flux is incident perpendicularly. The second conical flux is retroreflected from the other annular area on which the second conical flux is incident perpendicularly. Thus, the first and second conical fluxes return to the diffraction grating 22A.

<5> The reflected (retroreflected) fluxes incident on the diffraction grating 22A are converted into parallel fluxes and then incident on the reference surface 21A. The parallel fluxes are combined with the reference beam to form interference light.

<6> The interference light is incident on the imaging lens 15A through the collimator lens 14A and the beam splitter 13A. The imaging lens 15A focuses the interference light on the image sensor 17A of the imaging camera 16A. Thereby, images of first and second annular interference fringes are formed on the image sensor 17A. The first annular interference fringes correspond to the area on which the first conical flux is incident perpendicularly. The second annular interference fringes correspond to the area on which the second conical flux is incident perpendicularly. The imaging camera 16A takes an image of the first and second interference fringes. Image data of the taken image is outputted to the analyzing device 31 and stored in the storage unit.

<7> The analyzing device 31 analyzes the first and second interference fringes to measure surface misalignment (hereinafter referred to as the first surface misalignment) and angular misalignment (hereinafter referred to as the first angular misalignment) of the first sample surface 90A relative to the optical axis C_{22A} of the diffraction grating 22A. To be more specific, simultaneous equations, an equation obtained from phase information of the first interference fringes and an equation obtained from phase information of the second interference fringes, are solved to separate the first surface misalignment and the first angular misalignment from each other. Thus, the first surface misalignment and the first angular misalignment are obtained with high accuracy.

Here, α₁ denotes a wavefront propagation angle of the first conical flux relative to the optical axis C_{22A} of the diffraction grating 22A. L₁ denotes a diameter of the annular area on the first lens surface 93 on which the first conical flux is incident perpendicularly. α₂ denotes a wavefront propagation angle of the second conical flux relative to the optical axis C_{22A}. L₂ denotes a diameter of the annular area on the first lens surface 93 on which the second conical flux is incident perpendicularly. Note that the wavefront propagation angles α₁ and α₂ are obtained from design data of the diffraction grating 22A. The diameters L₁ and L₂ are obtained from design data of the first lens surface 93.

Assuming that there is no angular misalignment of the first sample surface 90A relative to the optical axis C_{22A} but surface misalignment by a distance D, a phase of the first interference fringes changes by 2Dsinα₁ in a radial direction. On the other hand, assuming that there is no surface misalignment of the first sample surface 90A relative to the optical axis C_{22A} but angular misalignment at an angle β, a phase of the first interference fringes changes by Lsin2β in the radial direction.

When there is the surface misalignment of the first sample surface 90A relative to the optical axis C₂₂ by the distance D and there is the angular misalignment at the angle β of the first sample surface 90A relative to the optical axis C₂₂, a phase change φ₁ in a radial direction of the first interference fringes is represented by an equation (A).

φ₁=2Dsinα₁+L₁sin2β (A)

In the same manner as the above, a phase change φ₂ in a radial direction of the second interference fringes is represented by an equation (B).

φ₂=2Dsinα₂+L₂sin2β (B)

By solving the above equations (A) and (B) as simultaneous equations, unknowns D and β are obtained.

<8> On the other hand, when the laser beam is outputted from the laser 11B of the second measuring unit 1B, the laser beam is incident on the beam splitter 13B through the beam diameter changing lens 12B. The incident laser beam is reflected upward from the beam splitting surface 13Ba of the beam splitter 13B, and incident on the collimator lens 14B. The laser beam incident on the collimator lens 14B is converted into a parallel laser beam and outputted to the reference plate 20B.

<9> The reference surface 21B separates the laser beam incident on the reference plate 20B into the two beams. One of the beams is reflected back as the reference beam to the collimator lens 14B. The remaining beam is outputted to the diffraction grating 22B.

<10> The diffraction grating 22B converts the parallel beam incident thereon into the two conical fluxes, the first conical flux and the second conical flux, that are different in the wavefront propagation angle. The first and second conical fluxes are outputted to the second sample surface 90B.

<11> The first and second conical fluxes outputted from the diffraction grating 22B are incident perpendicularly on the two annular areas around the center axis C₉₄ on the second lens surface 94, respectively. The first conical flux is retroreflected from one of the annular areas on which the first conical flux is incident perpendicularly. The second conical flux is retroreflected from the other annular area on which the second conical flux is incident perpendicularly. Thus, the first and second conical fluxes return to the diffraction grating 22B.

<12> The reflected (retroreflected) fluxes incident on the diffraction grating 22B from the annular areas are converted into parallel fluxes and then incident on the reference surface 21B. The parallel fluxes are combined with the reference beam to form the interference light.

<13> The interference light is incident on the imaging lens 15B through the collimator lens 14B and the beam splitter 13B. The imaging lens 15B focuses the interference light on the image sensor 17B of the imaging camera 16B. Thereby, images of third annular interference fringes and fourth annular interference fringes are formed on the image sensor 17B. The third annular interference fringes correspond to the area on which the first conical flux is incident perpendicularly. The fourth annular interference fringes correspond to the area on which the second conical flux is incident perpendicularly. The imaging camera 16B takes an image of the third and fourth interference fringes. Image data of the taken image is outputted to the analyzing device 31 and stored in the storage unit.

<14> The analyzing device 31 analyzes the third and fourth interference fringes to measure surface misalignment (hereinafter referred to as the second surface misalignment) and angular misalignment (hereinafter referred to as the second angular misalignment) of the second sample surface 90B relative to the optical axis C_{22B} of the diffraction grating 22B. To be more specific, simultaneous equations, an equation obtained from phase information of the third interference fringes and an equation obtained from phase information of the fourth interference fringes, are solved to separate the second surface misalignment and the second angular misalignment from each other. Thus, the second surface misalignment and the second angular misalignment are obtained with high accuracy (the details are similar to or the same as the method for obtaining the unknowns D and β described above).

<15> Using the first surface misalignment and the first angular misalignment obtained in the step <7> and the second surface misalignment and the second angular misalignment obtained in the step <14>, the relative surface misalignment and the relative angular misalignment between the first sample surface 90A and the second sample surface 90B are separated from each other, namely, the surface misalignment and the angular misalignment of the sample lens 9 are separated from each other. Thus, the surface misalignment and the angular misalignment of the sample lens 9 are obtained with high accuracy.

The embodiment of the present invention is described as above. However, the present invention is not limited to the above. The present invention is applicable to various embodiments with different configurations. For example, in the above embodiment, the diffraction grating 22A, being the measuring beam converting element, converts the measuring beam into the two or more conical fluxes that are different in the wavefront propagation angle relative to the optical axis C_{22A}. The diffraction grating 22B, being the measuring beam converting element, converts the measuring beam into the two or more conical fluxes that are different in the wavefront propagation angle relative to the optical axis C_{22B}. Alternatively, a refractive element can be used as the measuring beam converting element. To be more specific, a conical lens having conical surfaces with different inclination angles may be used. Thereby, the measuring beam is converted into two or more conical fluxes that are different in the wavefront propagation angle.

Alternatively, it is possible to use a measuring beam converting element capable of converting the measuring beam into a conical flux and a parallel flux with its wavefront perpendicular to the optical axis of the measuring beam. This is achieved with the use of, for example, a blazed diffraction grating composed of annular regions and a non-grating region in its center, a rectangular diffraction grating having annular regions for obtaining parallel fluxes using zero-order diffracted light, or a refractive element in a shape of an oblique truncated cone having top and bottom surfaces with different inclination angles. In such cases, a parallel flux is applied to a portion, on each of the sample surfaces, perpendicular to its center axis. Based on interference fringes formed by the flux reflected therefrom, an angular misalignment of each of the sample surfaces is obtained.

In the above embodiment, the two measuring units (the first measuring unit 1A and the second measuring unit 1B) are arranged to face each other with the sample lens 9 therebetween. Alternatively, the measurement can be performed using a single measuring unit. To measure every sample surface, the sample is turned upside down, for example. In this case, high coherent light beam causes multiple-interference of beams reflected from the sample surfaces. To prevent the multiple-interference, low coherent light beam can be used instead. In using the low coherent light beam, it is preferable to provide a detour unit for adjusting an optical path difference between a flux reflected from a sample surface and a reference beam to determine a position of the sample surface so as to form interference fringes.

Alternatively, a wavelength-variable laser or two or more light sources different in output wavelength may be used when the diffraction grating is used as the measuring beam converting element. Because a diffraction angle varies depending on the wavelength, the measuring beam can be converted into two or more conical fluxes that are different in the wavefront propagation angle.

In the above embodiment, the two conical fluxes are applied to each of the first lens surface 93 and the second lens surface 94. If a chamfered surface such as an R surface and/or a C surface is formed in a boundary between the first lens surface 93 and the flange upper surface 96, and/or a boundary between the second lens surface 94 and the flange lower surface 97, the two conical fluxes may be applied to the chamfered surface.

In the above embodiment, the diffraction grating, being the measuring beam converting element, converts the measuring beam into the two conical fluxes by way of example. The measuring beam converting element may convert the measuring beam into three or more deflected fluxes. In this case, the surface misalignment and the angular misalignment of the sample may be analyzed based on phase information of three or more sets of interference fringes obtained for each sample surface.

Alternatively, for example, a beam splitting element may be placed in a cavity enclosed by the two molding dies used for the injection molding. A light beam is outputted from an interferometric optical system to the beam splitting element to split the light beam into two beams. A measuring beam converting element is disposed on each of the optical paths of the two beams. Thereby, two or more deflected fluxes that are different in the wavefront propagation angle are applied to each of the two molding dies. Thus, surface misalignment and angular misalignment between the two molding dies are directly measured.

What is claimed is:

1. An apparatus for measuring surface misalignment and angular misalignment between two sample surfaces of a sample, each of the sample surfaces having a rotationally symmetric curved portion, the apparatus comprising:
a measuring beam converting element for converting a measuring beam into a first deflected flux and a second deflected flux, and outputting the first and second deflected fluxes to the sample, the first deflected flux being incident perpendicularly on a first area of the sample surface and reflected as a first reflected flux from the first area, the second deflected flux being incident perpendicularly on a second area of the sample surface and reflected as a second reflected flux from the second area, the measuring beam converting element outputting the first and second reflected fluxes, the first and second deflected fluxes having different wavefront propagation angles relative to an optical axis of the measuring beam converting element;
an interferometric optical system for outputting the measuring beam and forming first interference fringes and second interference fringes, the first interference fringes being formed by interference of the first reflected flux from the measuring beam converting element and a reference beam, the second interference fringes being formed by interference of the second reflected flux from the measuring beam converting element and the reference beam;
an imaging unit for imaging the first and second interference fringes; and
an analyzing unit for analyzing the surface misalignment and the angular misalignment based on phase information of the first and second interference fringes obtained for each of the two sample surfaces.

2. The apparatus of claim 1, wherein each of the deflected fluxes is a conical flux.

3. The apparatus of claim 2, wherein the measuring beam converting element is a diffraction grating.

4. The apparatus of claim 3, further comprising a reference plate having first and second surfaces, the first surface separating an incident laser beam into the measuring beam and the reference beam, and the second surface being the diffraction grating.

5. The apparatus of claim 1, wherein the two measuring beam converting elements, the two interferometric optical systems, and the two imaging units are arranged per sample to obtain the phase information of the first and second interference fringes for each of the two sample surfaces, the sample is placed between the two measuring beam converting elements, and between the two interferometric optical systems, and between the two imaging units.
